(19) United States
(12) Patent Application Publication
(10) Pub. No.: US 2007/0080620 A1
(43) Pub. Date: Apr. 12, 2007

(54) Arc tube and shroud holder

(76) Inventors: Elliot F. Wyner, Peabody, MA (US); Karen A. Provost, Manchester, NH (US); Ebon L. McCullough, New Ipswich, NH (US); Richard A. Kingston, Beverly, MA (US)

Correspondence Address: OSRAM SYLVANIA INC, 100 ENDICOTT STREET, DANVERS, MA, 01923, US

(21) Appl. No.: 11/481,145

(22) Filed: Jul. 5, 2006

Related U.S. Application Data
(60) Provisional application No. 60/724,042, filed on Oct. 6, 2005.

(51) Int. Cl. H01J 5/48; H01J 5/50

(52) U.S. Cl. 313/318.01

(57) ABSTRACT

A holder (50) for an arc tube-shroud assembly (52) (see FIGS. 3-5) comprises: a planar disc (54) having a plurality of shroud-holding arms (56) peripherally spaced about the disc and extending in a first direction (58). At least two arc tube holding arms 60 extend in an opposite direction (62) for positioning an arc tube (52a) laterally within a shroud (52b); and at least one arc tube locking tab (64) extends in the opposite direction (60) for positioning the arc tube (52a) axially within the shroud (52b). The planar disc (54) is provided with a plurality of venting apertures (82) sized to allow egress of pressurized gases but inhibit passage of axially-propelled arc tube shards in the event of a non-passive failure of an arc tube.

### CROSS-REFERENCE TO RELATED APPLICATION

This application claims priority from Provisional Application Ser. No. 60/724,042, filed Oct. 6, 2005.

### TECHNICAL FIELD

This invention relates to metal halide arc discharge lamps and more particularly to such lamps including a shroud. Still more particularly it relates to a holder for an arc tube-shroud assembly.

### BACKGROUND ART

Metal halide arc discharge lamps are frequently employed in commercial usage because of their high luminous efficacy and long life. A typical metal halide arc discharge lamp includes a quartz or fused silica arc tube that is hermetically sealed within a borosilicate glass outer envelope. The arc tube, itself hermetically sealed, has tungsten electrodes sealed into opposite ends and contains a fill material including mercury, metal halide additives and a rare gas to facilitate starting. In some cases, particularly in high wattage lamps, the outer envelope is filled with nitrogen or another inert gas at less than atmospheric pressure. In other cases, particularly in low wattage lamps, the outer envelope is evacuated.

It has been found desirable to provide metal halide arc discharge lamps with a shroud that comprises a generally cylindrical, light-transmissive member, such as quartz, that is able to withstand high operating temperatures. The arc tube and the shroud are coaxially mounted within the lamp envelope with the arc tube located within the shroud. Preferably, the shroud is a tube that is open at both ends. In other cases, the shroud is open on one end and has a domed configuration on the other end. Shrouds for metal halide arc discharge lamps are disclosed in U.S. Pat. No. 4,721,876 issued Jan. 26, 1988 to White et al.; U.S. Pat. No. 4,888,517 issued Dec. 19, 1989 to Keeffe et al.; U.S. Pat. No. 4,499,396 issued Feb. 12, 1985 to Fohl et al. and U.S. Pat. No. 4,580,989 issued Apr. 8, 1986 to Fohl et al. See also U.S. Pat. No. 4,281,274 issued Jul. 28, 1981 to Bechard et al. Shroud holders are shown in U.S. Pat. No. 6,930,443 issued Aug. 16, 2005 to Williamson et al.

The shroud has several beneficial effects on lamp operation. In lamps with a gas-filled outer envelope, the shroud reduces convective heat losses from the arc tube and thereby improves the luminous output and the color temperature of the lamp. In lamps with an evacuated outer envelope, the shroud helps to equalize the temperature of the arc tube. In addition, the shroud effectively reduces sodium losses. The shroud improves the safety of the lamp by acting as a containment device in the event that the arc tube shatters; however, the cost of the shroud can be detrimental.

The mounting of the arc tube-shroud assembly is usually accomplished be means of various clips, such as those shown in FIGS. 1, 1a, and 1b. While these clips have performed well, they are difficult to manufacture and assemble and additionally have evidenced problems of containment in the event of a non-passive failure of an arc tube, particularly in the handling of shards that can be expelled along the longitudinal axis of the lamp.

Additionally, the prior art holders occasionally allowed sufficient movement of the arc tube during required drop tests to cause a failure of the test.

### DISCLOSURE OF INVENTION

It is, therefore, an object of the invention to obviate the disadvantages of the prior art.

It is another object of the invention to enhance the operation of metal halide arc discharge lamps.

It is yet another object of the invention to provide an arc tube-shroud assembly that can be utilized with either probe or pulse start lamps.

These objects are accomplished, in one aspect of the invention by a holder for an arc tube-shroud assembly that comprises a planar disc having a plurality of shroud-holding arms peripherally spaced about said disc and extending in a first direction; at least two arc tube holding arms formed from said disc and extending in an opposite direction for positioning an arc tube laterally within a shroud; and at least one arc tube grabbing arm extending in said opposite direction for positioning and maintaining said arc tube axially within said shroud.

The objects are accomplished in another aspect of the invention by an arc tube-shroud assembly for a discharge lamp, the assembly comprising: a cylindrical shroud having a longitudinal axis; an arc tube coaxially mounted along the longitudinal axis within the shroud, the arc tube comprising a hollow bulbous body containing an arc generating and sustaining medium and oppositely disposed seal areas at the ends of the hollow bulbous body, each of the seal areas mounting an electrode therein and having flat sides containing at least one dimple; and a planar disc mounted on the ends of the shroud, the disc having a plurality of shroud-holding arms peripherally spaced about the disc and extending in a first direction and in contact with the shroud; at least two arc tube holding arms formed from the disc and extending in an opposite direction for positioning an arc tube laterally within a shroud, the at least two arms being in engagement with the flat sides of the seal areas; and at least one arc tube grabbing arm extending in the opposite direction for positioning the arc tube axially within the shroud with at least one arc tube grabbing arm being in engagement with the dimple.

The objects are achieved in yet another aspect of the invention by the provision of an arc discharge lamp having a lamp envelope and an arc tube-shroud assembly mounted within the envelope by a mounting frame; electrical lead-ins for supplying electrical energy to the arc tube; and a chemical fill within the arc tube to produce light when an arc is formed within the arc tube; wherein there is provided a holder for the arc tube-shroud assembly comprising: a planar disc having a plurality of shroud-holding arms peripherally spaced about the disc and extending in a first direction; at least two arc tube holding arms formed from the disc and extending in an opposite direction for positioning an arc tube laterally within a shroud; and at least one arc tube grabbing arm extending in the opposite direction for positioning the arc tube axially within the shroud.

Lamps so constructed have an arc tube-shroud assembly that positions the arc tube laterally and axially within the shroud in a manner to survive mandated drop tests and, additionally, provide a more advantageous design to obviate the emission of axially propelled shards in the event of a non-passive failure of the arc tube.

### BRIEF DESCRIPTION OF THE DRAWINGS

FIG. 1 is a perspective view of an exemplary arc discharge lamp employing an arc tube-shroud assembly;

FIG. 1a is an elevational view of a different exemplary arc discharge lamp employing a different arc tube-shroud assembly;

FIG. 1b is an elevational view of yet another exemplary arc discharge lamp employing still another arc tube-shroud assembly:

FIG. 2; is a perspective view of a holder for an arc tube-shroud assembly in accordance with an aspect of the invention;

FIG. 3 is a side elevational view of an arc tube-shroud assembly in accordance with an aspect of the invention;

FIG. 4 is an end elevational view of the assembly of FIG. 3; and

FIG. 5 is an opposite side elevational view of the assembly of FIG. 3.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

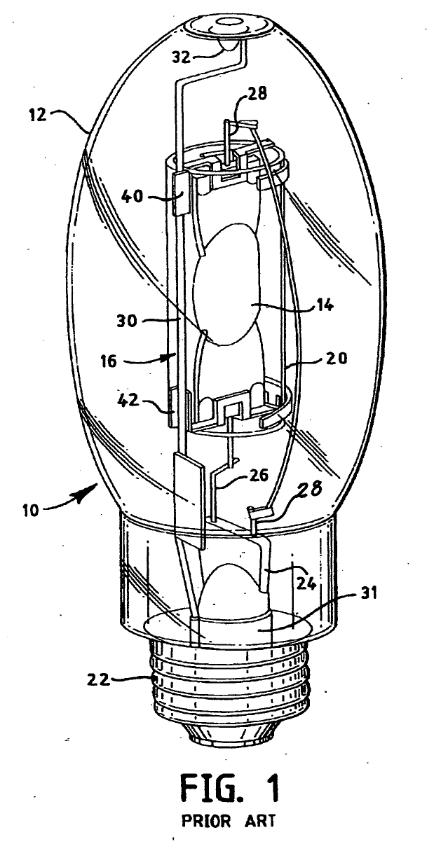

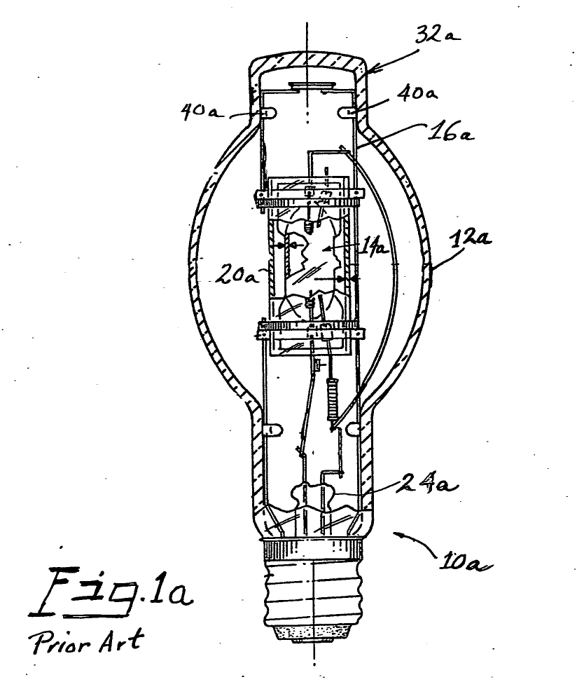

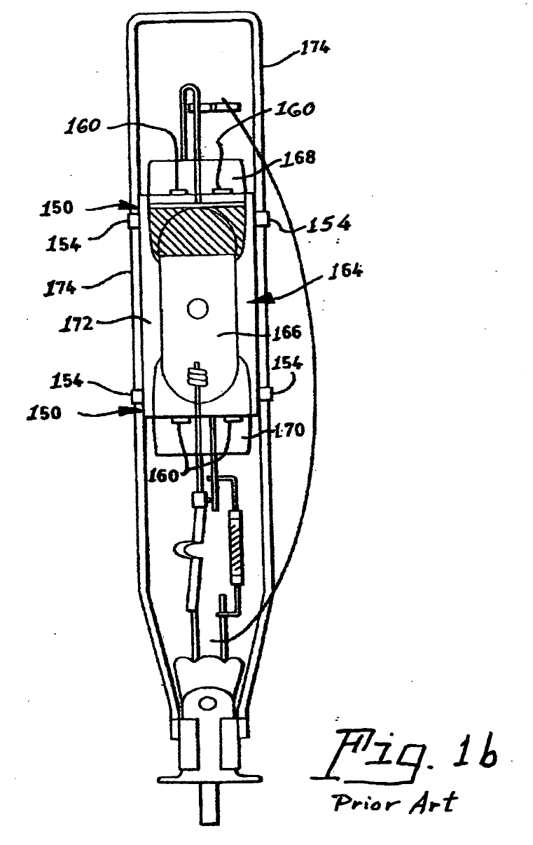

Referring now to the drawings with greater particularity, there is shown in FIG. 1 an exemplary metal halide arc discharge lamp 10 including a lamp envelope 12 and an arc tube 14 mounted within the envelope by mounting frame 16. The arc tube is positioned within a shroud 20, which is also supported by a single wire mounting frame 16. Electrical energy is coupled to the arc tube 14 through a base 22, a lamp stem 24 and electrical leads 26 and 28. The arc tube contains a chemical fill or dose of materials to provide light when an arc is initiated therein, as is known. The shroud 20 comprises a cylindrical tube of light transmissive, heat resistant material such as quartz.

As noted, in this particular instance, the mounting frame 16 supports both the arc tube 14 and the shroud 20 within the lamp envelope 12. The mounting frame 16 includes a metal support rod 30 attached to lamp stem 24 by a strap 31. The support rod engages an inward projection 32 in the upper end of the lamp envelope 12. The support rod 30 in its central portion is parallel to a central axis of the arc tube 14 and shroud 20. The mounting means 16 further includes an upper clip 40 and a lower clip 42, which secure both arc tube 14 and shroud 20 to support rod 30. The clips 40 and 42 are attached to the support rod 30, preferably by welding.

Positioned in a sealed manner at press-seal ends 43 of the arc tube 14 are electrode assemblies. Each electrode assembly comprises an electrode of a suitable material, such as tungsten, and may a have coil attached to one end thereof, internally of the arc tube; a molybdenum sealing foil attached to the other end of the electrode; and an in-lead attached to the opposite end of the molybdenum sealing foil and extending externally of the arc tube for making electrical connection thereto, as is known in the art.

FIG. 1a depicts a different arc tube-shroud mounting arrangement wherein an arc tube 14a is mounted within a shroud 20a. A frame 16a is comprised of multiple wire members and a plurality of snubbers 40 which, at the upper portion of the lamp, engage the interior walls of a dome 32a. The holder of this invention can be used with either a single or multiple wire frame; however, in the preferred mode, a multiple wire frame is used.

Another arc tube/shroud assembly for an arc discharge lamp is shown in FIG. 1b. Herein an arc tube 164 has a center portion 166 and opposite pinch seals 168, 170 and is mounted within a cylindrical shroud 172 by means of a pair of annular mounting members 150. The projections 160 that are formed on the mounting members 150 frictionally engage the pinch seals and make the arc tube/shroud assembly ready for fixation to the support rods 174 by use of the mounting tabs 154. The assembly shown in FIG. 1b utilizes two mounting tabs 154 on each of the annuli; however, if the supporting means shown in FIG. 1 is employed, where a single support rod 30 is used, the annuli need only have one mounting tab 54.

While all of the above-described prior art assemblies have been employed with some success, various problems, as discussed above, have existed.

Primary among these are the lack of consistency in retaining shards in the event of a non-passive failure of an arc tube and the lack of maintaining axial position during handling, as epitomized by mandated drop-testing procedures.

The instant invention, as described below, addresses these problems.

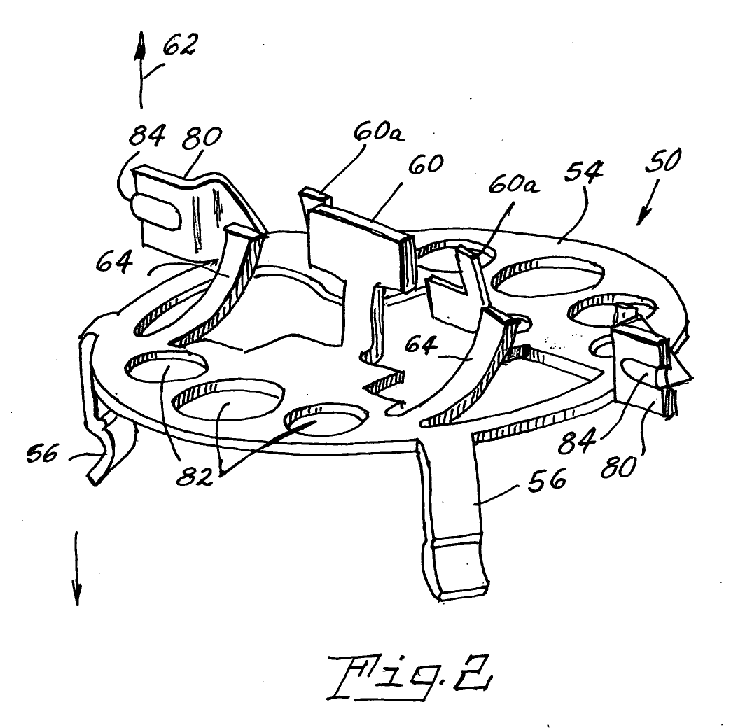

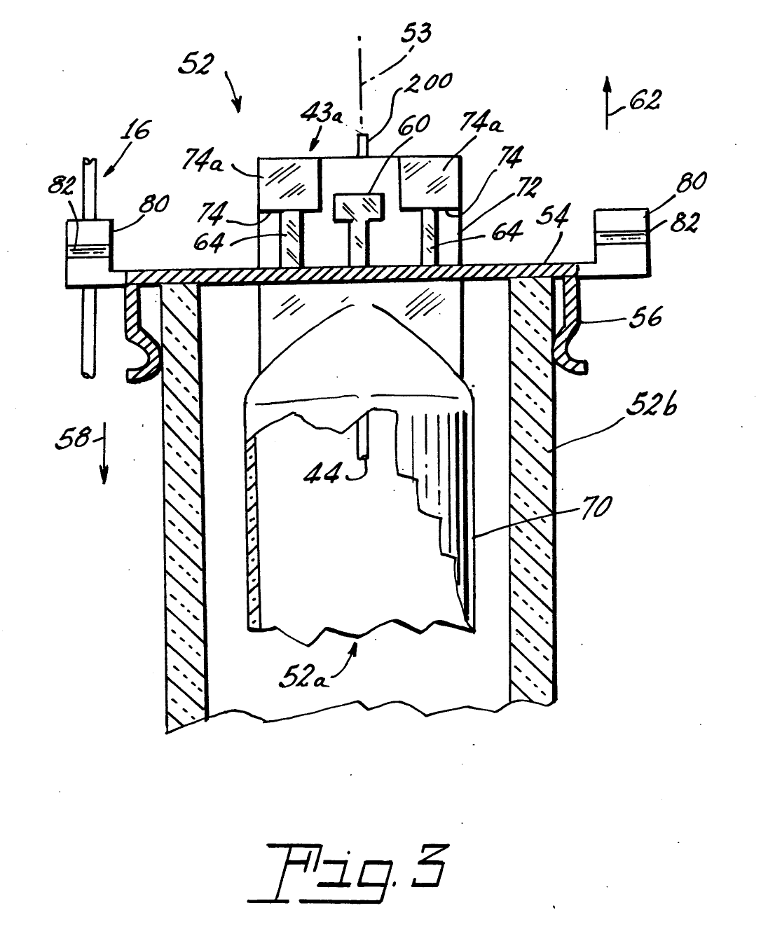

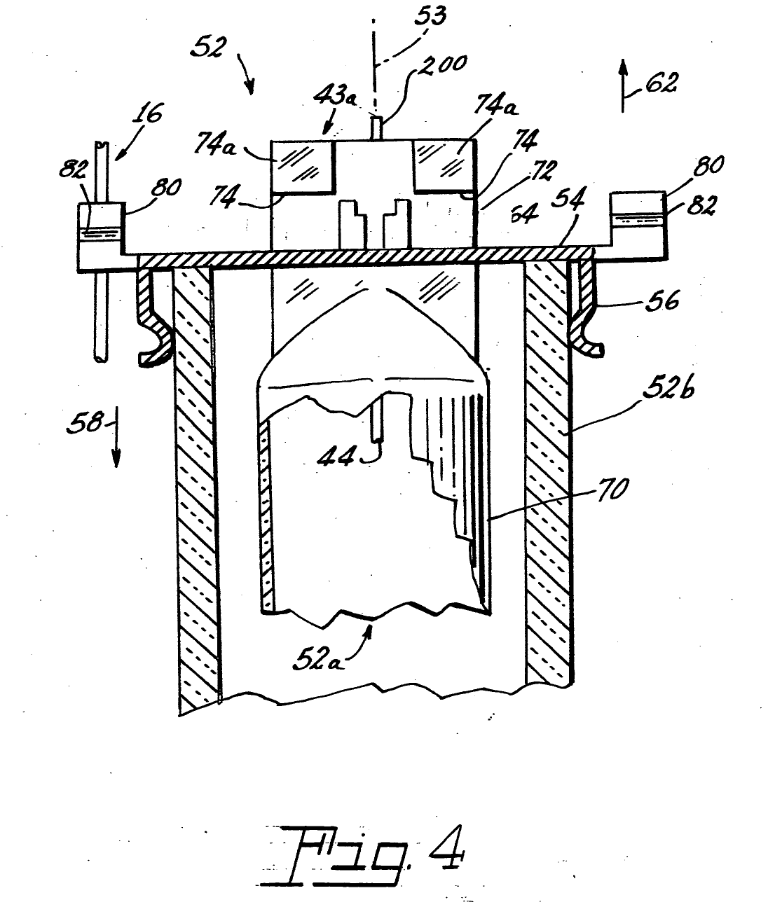

Referring now to FIG. 2 there is shown a holder 50 for an arc tube-shroud assembly 52 (see FIGS. 3-5) comprising: a planar disc 54 having a plurality of shroud-holding arms 56 peripherally spaced about the disc and extending in a first direction 58; at least two arc tube holding arms 60 extending in an opposite direction 62 for positioning an arc tube 52a laterally within a shroud 52b; and at least one arc tube locking tab 64 extending in the opposite direction 60 for positioning the arc tube 52a axially within the shroud 52b.

The planar disc 54 is provided with a plurality of venting apertures 82 sized to allow egress of pressurized gases but inhibit passage of axially-propelled arc tube shards in the event of a non-passive failure of an arc tube.

The planar disc 54 is preferably of metal and in a still more preferred embodiment the disc is of stainless steel. If magnetic equipment is employed in the manufacture of the lamps the disc can be nickel-plated steel or a magnetic stainless steel such as SS416. A preferred material for a non-magnetic material is 304 stainless steel.

An arc tube-shroud assembly 52 for a discharge lamp is shown in more detail in FIGS. 3-5. Therein, the assembly 52 comprises a cylindrical shroud 52b of a suitable material, such as quartz, having a longitudinal axis 53 with an arc tube 52a coaxially mounted along the longitudinal axis 53 within the shroud 52b. The arc tube 52a itself comprises a hollow bulbous body 70 containing an arc generating and sustaining medium and oppositely disposed seal areas 43a at the ends of the hollow bulbous body 70, each of the seal areas 43a mounting an electrode 44 therein (only one of which is shown) and having flat sides 72 containing at least one dimple 74 formed by a protrusion 74a. In a preferred embodiment there are two dimples 74 and two protrusions 74a, spaced on either side of the seal areas 43a The planar disc 54 is mounted on the ends of the shroud with the shroud-holding arms 56, which are peripherally spaced about the disc and extending in a first direction 58, in contact with the shroud 52b. In a preferred embodiment of the invention, there are three shroud holding arms 56, spaced 120° apart.

At least two arc tube holding arms 60a extend from the planar disc 54 in an opposite direction 62 for positioning the arc tube 52a laterally within the shroud 52b. The at least two arms 60a are in engagement with the flat sides 72 of the seal areas 43a and, when the arms are fabricated by stamping directly from the planar disc 54, need not be identical. For example, as shown in FIG. 3 an arm 60 can be “T” shaped and arms 60a on the opposite side of the seal 43a can be “L” shaped.

The “T” shaped arm 60 and “L” shaped arms 60a provide an added benefit by lying against the press seal very near the center of the seal area where the electrode lead-in 200 is sealed by means of a molybdenum ribbon, as is known. The mandated test for arc tube containment is described in ANSI 78.389 and requires a burst of current to the arc tube. It has appeared in the past that at least some failures of containment were caused by an excessive crack in the seal that initiates at the molybdenum ribbon of the electrode lead in and testing has emphasized that this failure mechanism does not occur in the arc tube-shroud assemblies described herein.

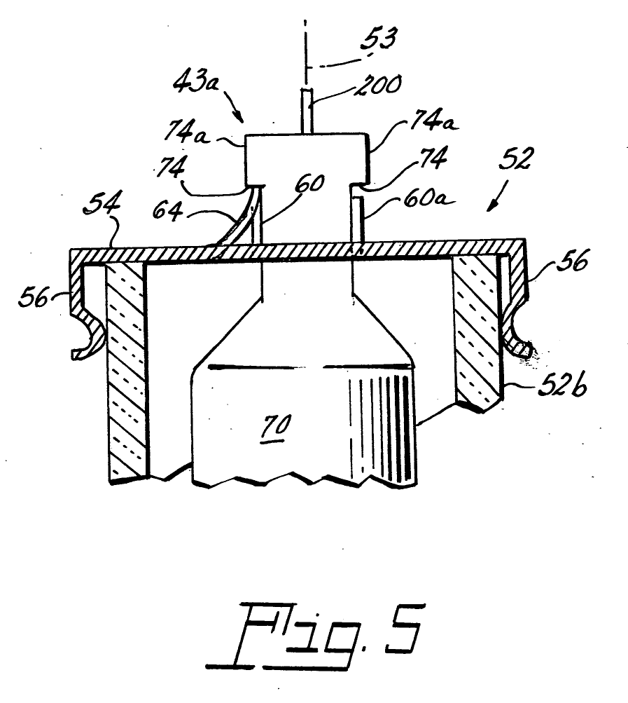

In a preferred embodiment of the invention the arms 60, 60a extend at 90° from the planar disc 54 so that their entire surface engages the flat area 72 of the seal area 43a, as shown in FIG. 5.

At least one and preferably two arc tube locking tabs 64 extend in the opposite direction 62 for positioning the arc tube 52a axially within the shroud 52b, the terminal ends of the locking tabs 64 being in engagement with the protrusions 74a.

Two oppositely disposed protruding ears 80 are provided on the planar disc 53 for attachment to a frame 16, as by welding, and are formed to project at an angle of 90° relative to the plane of the disc 54. The ears 80 are preferably provided with protrusions 84 for welding attachment to the wire frame 16. It has been found that if the ears 80 are straight there is a tendency for the ear-to-frame weld to break during drop testing. The addition of the protrusion 84 eliminated this problem by providing intimate engagement of the protrusion 84 with the wire frame thereby securing a stable weld.

The inclusion of the webbing formed by the venting apertures 82 has eliminated a failure type that was characterized by breakage of envelope domes, such as the dome 32a shown in FIG. 1a, during burst testing, and the design has further allowed the utilization of shorter shrouds, that is, shrouds that do not extend axially beyond the seal area, thus greatly reducing the cost of the assembly.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A holder for an arc tube-shroud assembly comprising:
a planar disc having a plurality of shroud-holding arms peripherally spaced about the disc and extending in a first direction;
at least two arc tube holding arms formed from the disc and extending in an opposite direction for positioning an arc tube laterally within a shroud; and
at least one arc tube grabbing arm extending in the opposite direction for positioning the arc tube axially within the shroud.

2. The holder of claim 1 wherein the planar disc includes protruding ears for attachment to a frame.

3. The holder of claim 1 wherein the at least two arc tube holding arms are formed to apply tension to opposite sides of an arc tube.

4. An arc tube-shroud assembly for a discharge lamp, the assembly comprising:
a cylindrical shroud having a longitudinal axis;
an arc tube coaxially mounted along the longitudinal axis within the shroud, the arc tube comprising a hollow bulbous body containing an arc generating and sustaining medium and oppositely disposed seal areas at the ends of the hollow bulbous body, each of the seal areas mounting an electrode therein and having flat sides containing at least one dimple; and
a planar disc mounted on the ends of the shroud, the disc having a plurality of shroud-holding arms peripherally spaced about the disc and extending in a first direction and in contact with the shroud;
at least two arc tube holding arms formed from the disc and extending in an opposite direction for positioning an arc tube laterally within a shroud, the at least two arms being in engagement with the flat sides of the seal areas; and
at least one arc tube-grabbing arm extending in the opposite direction for positioning the arc tube axially within the shroud, the at least one arc tube-grabbing arm being in engagement with the dimple.

5. In an arc discharge lamp having a lamp envelope and an arc tube-shroud assembly mounted within the envelope by mounting flame; electrical lead-ins for supplying electrical energy to the arc tube; and a chemical fill within the arc tube to produce light when an arc is formed within the arc tube; the improvement comprising:
a holder for the arc tube-shroud assembly comprising:
a planar disc having a plurality of shroud-holding arms peripherally spaced about the disc and extending in a first direction;
at least two arc tube holding arms formed from the disc and extending in an opposite direction for positioning an arc tube laterally within a shroud; and
at least one arc tube grabbing arm extending in the opposite direction for positioning the arc tube axially within the shroud.

6. The arc discharge lamp of claim 5 wherein the planar disc includes protruding ears for attachment to the frame.

7. The arc discharge lamp of claim 5 wherein the at least two arc tube holding arms are formed to apply tension to opposite sides of an arc tube.

8. A holder for an arc tube-shroud assembly comprising:
a planar disc having a plurality of shroud-holding arms peripherally spaced about the disc and extending in a first direction;
at least two arc tube holding arms extending in an opposite direction for positioning an arc tube laterally within a shroud; and
at least one arc tube locking tab extending in the opposite direction for positioning the arc tube axially within the shroud.

9. The holder of claim 8 wherein the planar disc is provided with a plurality of venting apertures sized to allow egress of pressurized gases but inhibit passage of axially-propelled arc tube shards in the event of a non-passive failure of an arc tube.
